(19) United States
(12) Patent Application Publication
(10) Pub. No.: US 2004/0012955 A1
(43) Pub. Date: Jan. 22, 2004

(54) Flashlight

(76) Inventor: Wen-Chang Hsieh, Sanchung City (TW)

Correspondence Address: Jackson Walker L.L.P., Suite 2100, 112 E. Pecan Street, San Antonio, TX, 78205, US

(21) Appl. No.: 10/197,914

(22) Filed: Jul. 17, 2002

(51) Int. Cl. F21L 4/00

(52) U.S. Cl. 362/202; 362/205; 362/206; 362/208; 362/800

(57) ABSTRACT

A flashlight has a barrel formed with a conductive inner surface to retain batteries therein, a head attached to one end of the barrel and having a light emitting module retained inside the head, wherein two electrodes of the light emitting module are respectively and electrically contacted with one electrode of the batteries and the conductive inner surface of the barrel. A tail cap is provided to enclose the other end of the barrel, wherein the screwing rotation between the tail cap and the barrel determines whether an electrical loop is closed or open so as to control the activation of the flashlight.

### BACKGROUND OF THE INVENTION

1. Field of Invention

The present invention relates to a flashlight, and more particularly to a flashlight that is easy to turn on/off and has superior waterproof ability.

2. Related Art

Conventionally, a switch of a flashlight is attached at the outer periphery of a barrel of the flashlight, and is moved upward/downward to close or open a circuit loop so as to turn on/off the flashlight. However, since consumers require superior usability of the flashlight, such as waterproof ability, the conventional flashlight can not fully meet the consumers' requirements.

With reference to FIG. 6, a conventional flashlight capable of adjusting the focus of light beam comprises a barrel (70) having a conductive sleeve (701) provided inside the barrel (70), and several batteries (71) retained therein. A tail cap (72) encloses a first end of the barrel (70) by means of threading so that the sleeve (701) is electrically contacted with the cathode of the series-connected batteries (71).

A head assembly enclosing a second end of the barrel (70), wherein the head assembly comprises a head (75) to which is affixed a face cap (750) that retains a lens (not numbered). The anode of the series-connected batteries is urged into contact with a first conductor (731) of a lower insulator receptacle (73). The lower insulator receptacle (73) also has affixed therein a second conductor (732) to contact with the sleeve (701), wherein when the head (75) is fully screwed onto the barrel (70), the second conductor (732) is separated from the sleeve (701). Both the first conductor (731) and the second conductor (732) pass through holes defined in the lower insulator receptacle (73) in an axial direction, and both frictionally receive and retain the terminal electrodes of a lamp bulb (74).

The head (75) further has a parabolic reflector (753) disposed within the head (75). A waterproof ring (751) is placed between the face cap (750) and the head (75) to provide a water-tight seal, and another waterproof ring (752) is provided between the head (75) and the barrel (70).

An upper insulator receptacle (76) is disposed external to the end of the barrel (70) whereat the lower insulator receptacle (73) is installed. The upper insulator receptacle (76) has extensions that are configured to mate with the lower insulator receptacle (73) to maintain an appropriate spacing between opposing surfaces of the upper insulator receptacle (76) and the lower insulator receptacle (73). The two electrodes of the lamp bulb (74) pass through the upper insulator receptacle (76) and electrically contact with the first conductor (731) and the second conductor (732), respectively.

The lower insulator receptacle (73) is urged in the direction indicated by an arrow “A”, by the action of a spring (not numbered) of the tail cap (72). When the head (75) is fully screwed onto the barrel (70) by means of the threads, the central portion of the reflector (753) surrounding a hole formed for passage of the lamp bulb (74), is forced against the outermost surface of the upper insulator receptacle (76), urging it in a direction counter to that indicated by the arrow “A”.

The upper insulator receptacle (76) then pushes the lower insulator receptacle (73) in the same direction, thereby providing a space between the surface of the lower insulator receptacle (73) and the sleeve (701) on the forward end of the barrel (70). The second conductor (732) is thus separated from contact with the sleeve (701) so that the loop is broken and the lamp bulb (74) is not actuated.

On the contrary, an appropriate rotation of the head (75) about the axis of the barrel (70) causes the whole head assembly to move in a direction indicated by the arrow “A”. Until the head assembly has progressed a sufficient distance in the direction of the arrow “A” such that the reflector (753) has also moved a like distance. Thus the upper insulator receptacle (76) and the lower insulator receptacle (73) are moved in the direction of the arrow “A”. In this position, the second conductor (732) is brought into contact with the sleeve (701) at the forward end of the barrel (70). Thus the electrical loop is formed and the lamp bulb (74) is actuated.

The focus of the light beam emitted from the lamp bulb (74) can be adjusted by the rotation of the head (75). However, the multi-stage design of the head assembly, i.e. the threading relationship between the head (75) and the barrel (70), will reduce the waterproof ability even when the waterproof rings (751)(752) are applied.

To overcome the shortcomings, a flashlight in accordance with the present invention obviates or mitigates the aforementioned drawbacks.

### SUMMARY OF THE INVENTION

The primary objective of the present invention is to provide a flashlight that is convenient to turn on/off and has superior waterproof ability than prior arts.

To achieve the objective, the flashlight comprises:

a barrel formed with a conductive inner surface and having batteries arranged in series therein;

a head affixed to a first end of barrel, wherein a face cap is further enclosed at a forward end of the head by threading and a reflector is retained inside the face cap;

a light emitting module mounted inside the head and adjacent to the first end of the barrel, wherein the lamp bulb module has two electrodes respectively in contact with an anode of the batteries and the conductive inner surface of the barrel;

a tail cap made up of metallic conductive material, wherein a base defined with a cavity is integrally formed at a center of the tail cap, a conductor is elastically retained inside the cavity for contacting with a cathode of the batteries, and an isolator encircles an outer periphery of the base to screw to a second end of the barrel.

Since the activation of the flashlight is performed by the rotating action of the tail cap not the head, the head is able to integrally form with the barrel to enhance the waterproof ability so that potential damage caused by water to the light emitting module disposed inside the head is avoided.

The light emitting module comprises a circuit board and at least one light emitting element, such as a bulb or an LED, mounted on a top surface of the circuit board. Two electrodes of the light emitting element are respectively and electrically connected to a center electrode and a ring shaped electrode formed on a bottom surface of the circuit board via the circuit layouts. The center electrode is adapted to contact with the anode of the batteries and the ring shaped electrode is adapted to contact with the conductive inner surface of the barrel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a flashlight in accordance with the present invention;

FIG. 2 is a cross sectional view of the flashlight in accordance with the present invention;

FIG. 3 is a perspective view of a flashlight in accordance with the present invention;

FIG. 4 is partial cross sectional view of the flashlight showing a tail cap separated from a barrel in accordance with the present invention;

FIG. 5 is partial cross sectional view of the flashlight showing the tail cap electrically contacted with the barrel in accordance with the present invention; and

FIG. 6 is a conventional flashlight cross sectional view.

### DETAILED DESCRIPTION OF THE INVENTION

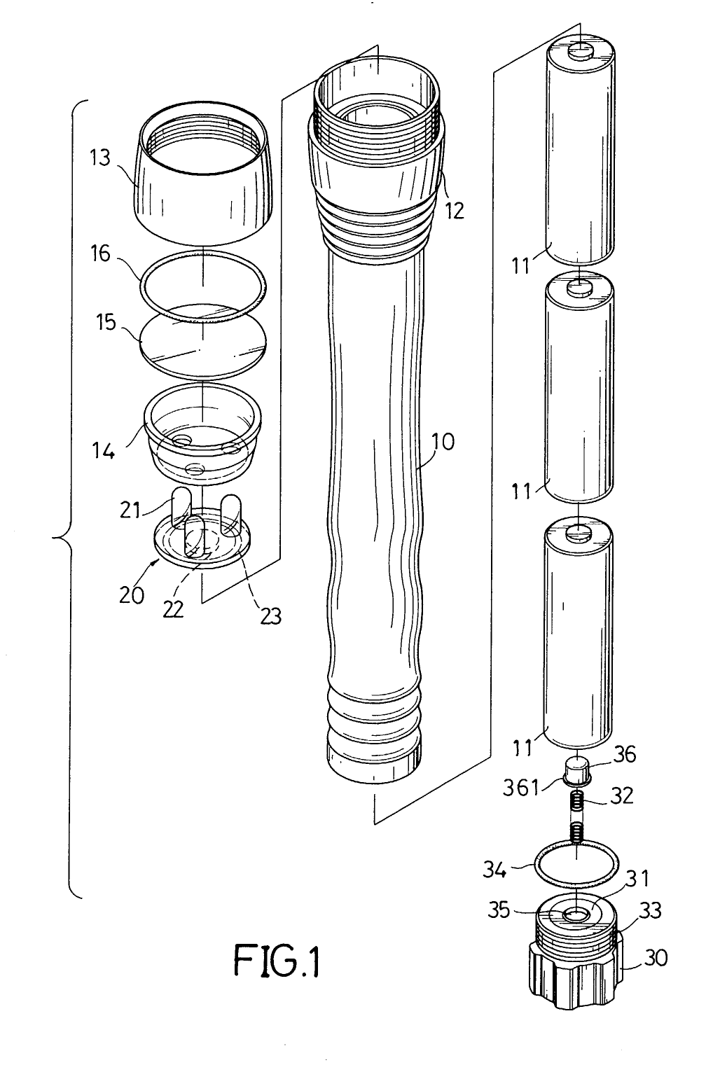

With reference to FIG. 1, a flashlight in accordance with the present invention has a barrel (10) inside which a conductive inner surface is formed and batteries (11) are retained. A head (12) is integrally affixed to an outer periphery of a first end of the barrel (10), wherein a face cap (13) is screwed to a forward end of the head (12) through corresponding threads (not numbered). A waterproof ring (16), a transparent lens (15) and a reflector (14) are sequentially disposed inside the face cup (13). The reflector (14) is formed as a substantially bowled shape and defines several through holes at the bottom thereof.

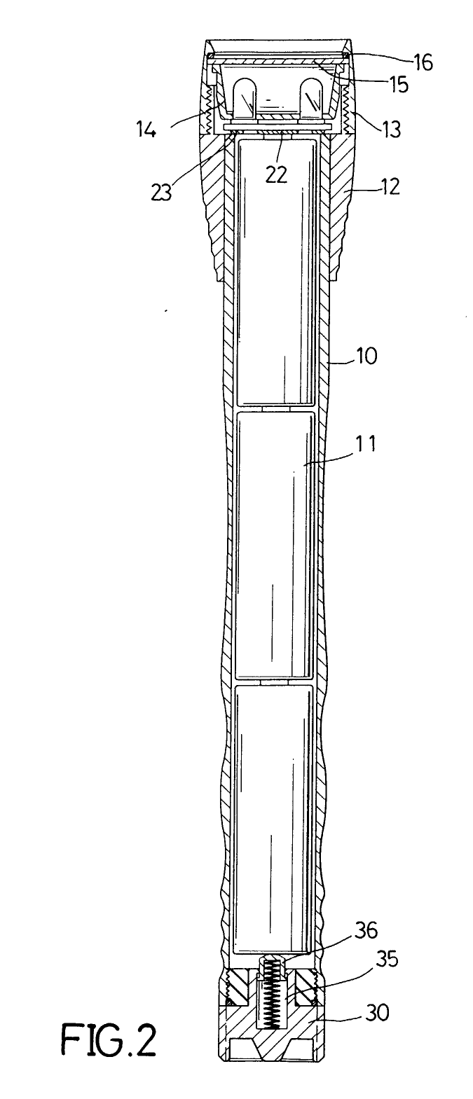

A light emitting module (20) is attached at the first end of the barrel (10) and inside the head (12). The module (20) is composed of a circuit board on which is mounted at least one light emitting element (21) that passes into the holes of the reflector (14). In this embodiment, three LEDs are mounted on the circuit board, where the bulb is another alternative preferable choice of the light emitting element (21). With reference to FIG. 2, one electrode of each light emitting element (21) is electrically connected to a center electrode (22) formed on a bottom surface of the circuit board through the circuit layouts. Similarly, the other electrode of each light emitting element (21) is electrically connected to a ring shaped electrode (23) that is formed on the bottom surface and around the rim of the circuit board. Further, the center electrode (22) is adapted to electrically contact with the anode of the batteries (1), and the ring shaped electrode (23) is to contacted with the conductive inner surface of the barrel (10).

With reference to FIGS. 1 and 2, a tail cap (30) with a substantially corrugated outer surface is formed as a cylinder shape and made of metallic material. An outer diameter of the tail cap (30) is corresponded to an outer diameter of the barrel (10). A base (31) is integrally formed with and extends upward from the tail cap (30), wherein a cavity (35) is defined in the center of the base (31) to retain a spring (32) and a conductor (36) that is adapted to contact with the cathode of the batteries (11). An electrical isolating ring (33) is provided to surround the base (31), wherein threads formed around the isolating ring (33) are correspondingly to screw to threads formed around the inner surface of a second end of the barrel (10). An outer diameter of the isolating ring (33) is smaller than the inner diameter of the barrel (10) so that the isolating ring (33) is able to insert into the barrel (10). A waterproof ring (34) is placed around the isolating ring (33), so when the tail cap (30) is screwed to the barrel (10), the waterproof ring (34) is located between the tail cap (30) and the barrel (10) to provide a water-tight seal.

The conductor (36) is fabricated as a hat shape and has a pit (not numbered) defined therein to retain the spring (32), wherein a brim (361) is integrally formed along the rim of the pit. After the spring (32) together with the conductor (36) is placed into the chamber (35) of the tail cap, pressure force from a punching or stamping action is applied downward to press the rim of the chamber (35) so that the rim of the chamber (35) is slightly deformed against the brim (361) of the conductor (36). Therefore the brim (361) of the conductor (36) enables the conductor (36) to be retained inside the chamber (35).

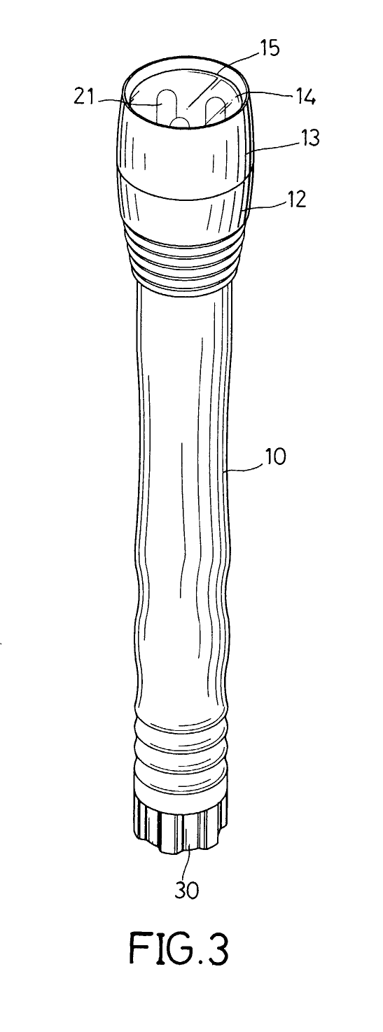

As shown in FIG. 3, all elements described foregoing are assembled together to form the flashlight in accordance with the present invention. The operation of the flashlight is explained hereinafter.

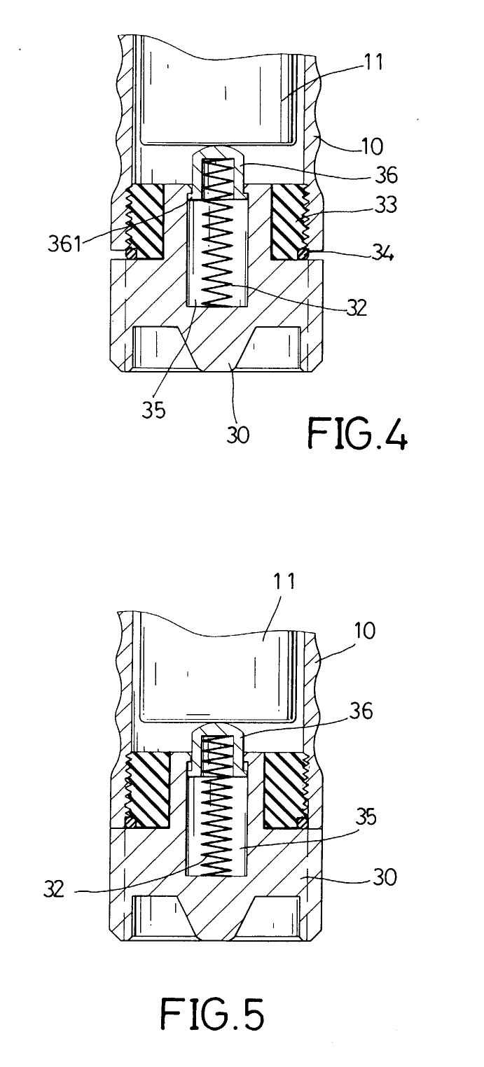

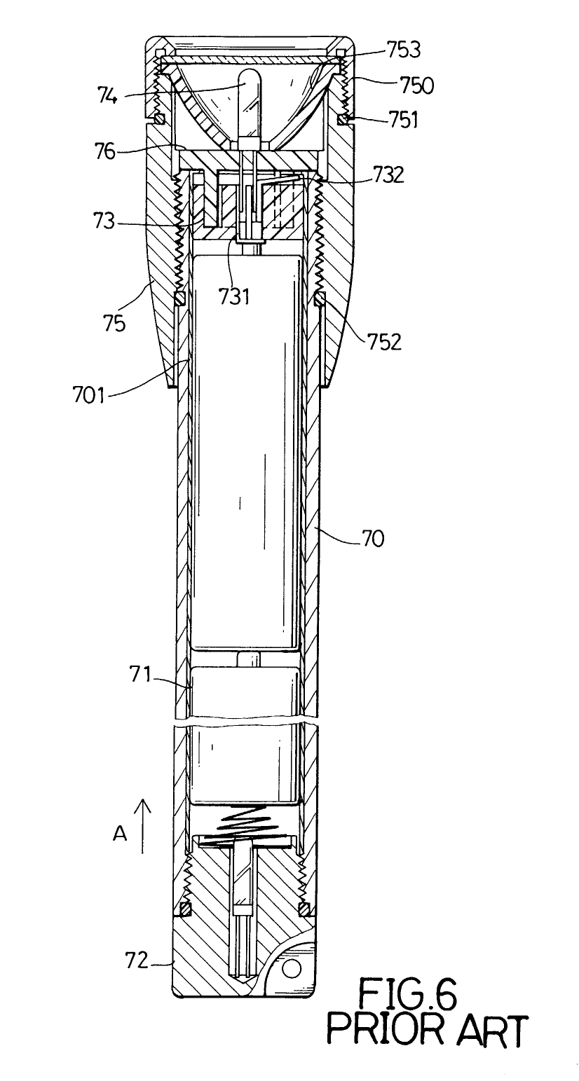

Firstly, with reference to FIG. 2, since the light emitting elements (21) of the light emitting module (20) are kept in contact with the center electrode (22) and the ring shaped electrode (23), whether the electrical loop of the flashlight is closed or open is determined by the rotation of the tail cap (30). With reference to FIG. 4, when the tail cap (30) is retained inside but not completely screwed into the second end of the barrel (10), the tail cap is not contacted with the barrel (10) so the electrical loop is open, whereby all light emitting elements are not activated.

On the contrary, when the tail cap (30) is completely screwed into the second end of the barrel (10), the tail cap (30) is contacted with the barrel (10) so that each light emitting element is activated based on the closed electrical loop.

In accordance with the foregoing detailed description of the present invention, since the activation of the flashlight is performed by the rotating action of the tail cap, the head is able to integrally form with the barrel to enhance the waterproof ability so that potential damage caused by water to the light emitting module disposed inside the head is avoided.

The invention may be varied in many ways by a skilled person in the art. Such variations are not to be regarded as a departure from the spirit and scope of the invention, and all such modifications are intended to be included within the scope of the following claims.

What is claimed is:

1. A flashlight comprising:
a barrel inside which a conductive inner surface is formed and batteries are retained;
a head integrally affixed to an outer periphery of a first end of the barrel, wherein a face cap is screwed to a forward end of the head and a reflector is retained inside the face cap;
a light emitting module attached at the first end of the barrel and inside the head, wherein the light emitting module has two electrodes respectively and electrically contacted with an anode of the batteries and the conductive inner surface of the barrel; and
a tail cap made up of conductive material, wherein a base is integrally formed with and extends upward from the tail cap, a cavity is defined in the base to retain a spring and a conductor that is to contact with a cathode of the batteries, and an electrical isolating ring to screw to a second end of the barrel surrounding the base.

2. The flashlight as claimed in claim 1, wherein the light emitting module comprises:
a circuit board on which is mounted at least one light emitting element, wherein a first electrode of the at least one light emitting element is electrically connected to a center electrode formed on a bottom surface of the circuit board through circuit layouts of the circuit board, and a second electrode of the at least one light emitting element is electrically connected to a ring shaped electrode that is formed on the bottom surface and around a rim of the circuit board,
wherein the center electrode is to electrically contact with the anode of the batteries, and the ring shaped electrode is to contact with the conductive inner surface of the barrel.

3. The flashlight as claimed in claim 2, wherein the at least one light emitting element is a lamp bulb.

4. The flashlight as claimed in claim 2, wherein the at least one light emitting element is an LED.

5. The flashlight as claimed in claim 1, wherein a waterproof ring is placed around the isolating ring to provide a water-tight seal between the tail cap and the barrel.

6. The flashlight as claimed in claim 1, wherein the conductor is formed as a hat shape and has a pit defined therein to retain the spring, wherein a brim is integrally formed along a rim of the pit.

7. The flashlight as claimed in claim 1, wherein the tail cap is formed with a substantially corrugated outer surface.
